(19) United States
(12) Patent Application Publication
(10) Pub. No.: US 2005/0198600 A1
(43) Pub. Date: Sep. 8, 2005

(54) Layout verifying device verifying an interconnection layout

(75) Inventor: Takao Hasegawa, Hyogo (JP)

Correspondence Address: MCDERMOTT WILL & EMERY LLP, 600 13TH STREET, N.W., WASHINGTON, DC, 20005-3096, US

(73) Assignee: RENESAS TECHNOLOGY CORP.

(21) Appl. No.: 10/992,686

(22) Filed: Nov. 22, 2004

(30) Foreign Application Priority Data
Mar. 4, 2004 (JP) 2004-060978(P)

(51) Int. Cl. G06F 17/50

(52) U.S. Cl. 716/5; 716/8

(57) ABSTRACT

An interconnection-allowed region determining portion refers to an interconnection information storing portion and an element information storing portion, and determines an allowed region allowing arrangement of an interconnection based on a position of an element having a terminal connected to the interconnection. A detouring portion detecting portion detects a portion of the interconnection outside the allowed region as a detouring portion. The detour determining portion determines the interconnection having the detouring portion as a detouring interconnection.

### BACKGROUND OF THE INVENTION

1. Field of the Invention

The present invention relates to a layout verifying device, and particularly to a layout verifying device verifying a layout of interconnections.

2. Description of the Background Art

A layout of interconnections in a semiconductor integrated circuit is verified after it is designed. Conventionally, this verification is performed by visually checking whether a short circuit is present between an interconnection in a power supply system and an interconnection in a ground system or not.

Since scales and packing densities of the semiconductor integrated circuits have increased in recent years, it is difficult to perform entire verification only by visual checking, and it has been proposed to perform a part of layout verification by automatic operations.

For example, Japanese Patent Laying-Open No. 09-198414 has disclosed a method of narrowing a range where an interconnection may be short-circuited. In this method, pattern data 11, which allows recognition of an interconnection name, is divided into rectangular data (12), and data 13 is produced by assigning a name to the divided data. From data 13, circuit connection information and used layer information are extracted (15) based on a technology rule 14 for extracting device/circuit connection information, interconnection layer and connection terminal information, and the connection information of the rectangular data thus extracted is stored as data of a tree structure. The data thus stored is analyzed (18) in accordance with a verification rule 17 to detect circuit connection, violation of rules, layers used by interconnections of respective names, and connection terminal violation. From a result 19 of error thus obtained, rectangular data having no direction relationship with the error position is eliminated (20) based on the connection information of the rectangular data so that an error result 21, in which an error position range is narrowed, is produced.

According to the Japanese Patent Laying-Open No. 09-198414, the above structure can detect the interconnection not to be connected by easily narrowing the error range from results of verification even if such narrowing of the error range is difficult in a conventional manner.

According to the Japanese Patent Laying-Open No. 09-198414, however, a range of the short circuit is merely narrowed, and the short circuit position cannot be detected with high reliability. Further, the range is not narrowed sufficiently. Therefore, a user must visually check whether the short circuit actually occurred in the narrowed range or not. This puts a burden on the user.

Further, according to the Japanese Patent Laying-Open No. 09-198414, it is impossible to determine whether the interconnection has a surplus portion or not, and to determine whether the interconnection has a detouring form or not.

### SUMMARY OF THE INVENTION

Accordingly, an object of the invention is to provide a layout verifying device, which can easily detect a detouring portion of an interconnection.

Another object of the invention is to provide a layout verifying device, which can easily detect a short circuit or a surplus portion of an interconnection with high reliability.

According to an aspect of the invention, a layout verifying device for verifying a layout of an interconnection includes a unit determining an allowed region of arrangement of the interconnection based on a position of an element having a terminal connected to the interconnection; and a determining unit determining that the interconnection has a detouring form, when the interconnection does not stay within the allowed region.

According to another aspect of the invention, a layout verifying device for verifying a layout of an interconnection includes a unit producing or obtaining data of a layout image of the interconnection; and a determining unit determining that the interconnection in the layout image is short-circuited or has a surplus portion, when a predetermined pattern is present in a block defined by dividing the data of the layout image of the interconnection into the blocks.

According to the former aspect of the invention, the layout verifying device can easily determine whether the interconnection has a detouring form or not.

According to the latter aspect, the layout verifying device can determine with high reliability whether the interconnection has a short-circuited portion or a surplus portion, or not.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 shows a structure of a layout verifying system according to a first embodiment of the invention.

FIG. 2 illustrates an example of interconnection information.

FIG. 3 illustrates an example of element information.

FIG. 4 is a flowchart illustrating operation procedures of the layout verifying system according to the first embodiment of the invention.

FIG. 5 illustrates a positional relationship between interconnection information relating to an interconnection, arrangement information of elements connected to the interconnection and interconnection-allowed region information.

FIG. 6 shows a layout screen image displayed by a display device 150 after determination about a detour.

FIG. 7 illustrates a positional relationship between interconnection information relating to another interconnection, arrangement information of elements connected to the interconnection and interconnection-allowed region information.

FIG. 8 shows a layout screen image displayed by display device 150 after determination about a detour.

FIG. 9 shows a structure of a layout verifying system according to a second embodiment of the invention.

FIG. 10 is a flowchart illustrating operation procedures of the layout verifying system according to the second embodiment of the invention.

FIG. 11 illustrates a positional relationship between interconnection information relating to an interconnection, arrangement information of elements connected to the interconnection and interconnection-allowed region information.

FIG. 12 shows a layout screen image of an interconnection and elements displayed by display device 150 controlled by an interconnection display control portion 21.

FIG. 13 shows an interconnection-allowed region image produced by an imaging device 160 controlled by interconnection-allowed region image production control portion 22.

FIG. 14 shows a layout screen image displayed by display device 150 after determination about a detour.

FIG. 15 shows a structure of a layout verifying system according to a third embodiment of the invention.

FIG. 16 shows a cross pixel pattern.

FIG. 17 is a flowchart illustrating operation procedures of a layout verifying system according to the third embodiment of the invention.

FIG. 18A shows an ideal layout of interconnections, and FIG. 1 8B shows a layout provided after designing interconnections.

FIG. 19 shows results of primary detection processing by pattern recognizing device 130, and particularly shows a block containing a cross pattern and blocks not containing a cross pattern.

FIG. 20 shows results of secondary detection processing by pattern recognizing device 130, and particularly shows block groups containing the cross patterns.

FIG. 21 illustrates a structure of the layout verifying system according to a fourth embodiment of the invention.

FIG. 22A shows a cross pixel pattern, FIG. 22B shows L-shaped pixel patterns and FIG. 22C shows T-shaped pixel patterns.

FIG. 23 is a flowchart illustrating operation procedures of the layout verifying system according to the fourth embodiment of the invention.

FIG. 24 shows results of primary detection processing by a pattern recognizing device 140, and particularly shows a block containing a cross pattern, a block containing an L-shaped pattern and blocks containing T-shaped patterns.

FIG. 25 shows a block group containing cross patterns.

FIG. 26A shows results of secondary detection processing by pattern recognizing device 140, and particularly shows a layout image of interconnections having a line width other than one pixel, and FIG. 26B is a layout image after processing of narrowing the line width of the interconnection to one pixel.

### DESCRIPTION OF THE PREFERRED EMBODIMENTS

Embodiments of the invention will now be described with reference to the drawings.

[First Embodiment]

(Structure)

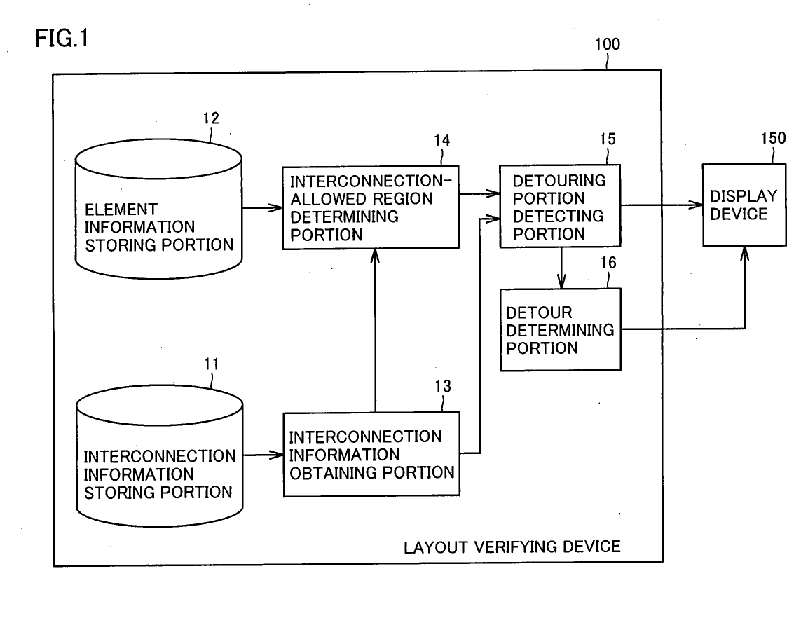

FIG. 1 shows a structure of a layout verifying system according to an embodiment of the invention. Referring to FIG. 1, the layout verifying system includes a layout verifying device 100 and a display device 150. Layout verifying device 100 includes an interconnection information storing portion 11, an element information storing portion 12, an interconnection information obtaining portion 13, an interconnection-allowed region determining portion 14, a detouring portion detecting portion 15 and a detour determining portion 16.

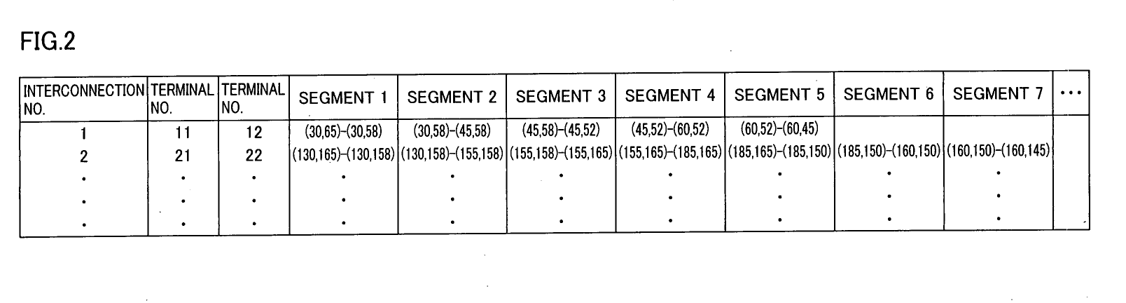

Interconnection information storing portion 11 stores interconnection information. FIG. 2 illustrates an example of the interconnection information. Referring to FIG. 2, the interconnection information includes interconnection numbers for identifying respective interconnections, terminal numbers for identifying terminals connected to the interconnections, and information relating to segments forming the interconnections. The information of each segment includes (X coordinate, Y coordinate) of each of opposite ends thereof. For example, two terminals connected to the interconnection of the interconnection number “1” bear the terminal numbers “11” and “12”, respectively, and the interconnection of the interconnection number “1” is formed of six segments. The coordinates of the opposite ends of a segment 1 are (30, 65) and (30, 58), and the coordinates of the opposite ends of a segment 2 are (30, 58) and (45, 58), respectively. The coordinates of the opposite ends of a segment 3 are (45, 58) and (45, 52), the coordinates of the opposite ends of a segment 4 are (45, 52) and (60, 52), and the coordinates of the opposite ends of a segment 5 are (60, 52) and (60, 45), respectively.

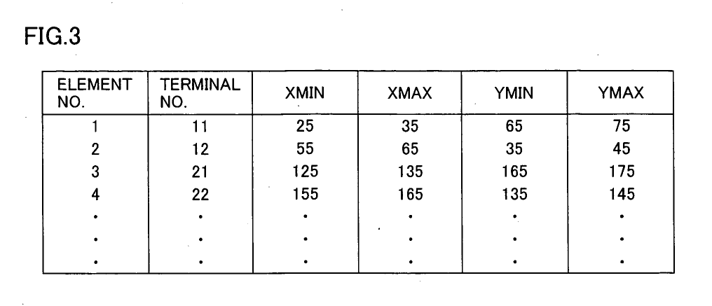

Element information storing portion 12 stores the element information. FIG. 3 shows an example of the element information. Referring to FIG. 3, the element information includes element numbers for identifying the respective elements, terminal numbers for identifying the terminals of the elements, and arrangement information representing arrangements of the elements. The arrangement information of the elements includes a minimum value XMIN and a maximum value XMAX of the X coordinate of the region, in which each element is arranged, as well as a minimum value YMIN and a maximum value YMAX of the Y coordinate of the above region.

Interconnection information obtaining portion 13 reads items of the interconnection information from interconnection information storing portion 11 one by one, and provides it to interconnection-allowed region determining portion 14.

Interconnection-allowed region determining portion 14 receives the interconnection information, and determines the terminals of the interconnection identified by the received information. Further, interconnection-allowed region determining portion 14 refers to element information storing portion 12, and identifies the elements having the terminals thus determined. Interconnection-allowed region determining portion 14 reads the arrangement information of the elements bearing two element numbers obtained from element information storing portion 12, and determines the interconnection-allowed region based on the arrangement information thus read. More specifically, interconnection-allowed region determining portion 14 reads the arrangement information (XMIN(1), XMAX(1), YMIN(1), YMAX(1)) of one of the elements and the arrangement information (XMIN(2), XMAX(2), YMIN(2) YMAX(2)) of the other element, selects a smaller one between XMIN(1) and XMIN(2) as X1, and selects a larger one between XMAX(1) and XMAX(2) as X2. Also, interconnection-allowed region determining portion 14 selects a smaller one between YMIN(1) and YMIN(2) as Y1, and selects a larger one between YMAX(1) and YMAX(2) as Y2. Interconnection-allowed region determining portion 14 operates based on the relationships of (X1′=(X1−α), X2′=(X2 +α), Y1′=(Y1−α), Y2′=(Y2+α)), determines a region, which is defined by the X coordinate from X1′ to X2′ and the Y coordinate from Y1′ to Y2′, as the interconnection-allowed region, and provides interconnection-allowed region information (X1′, X2′, Y1′, Y2′) representing the region thus determined to detouring portion detecting portion 15. In the above manner, α is subtracted or added. The purpose of this is to provide a margin for leading the interconnection from the terminal in such a structure that the X coordinate of the terminal connected to the interconnection is close to X1 or X2, or the Y coordinate of the terminal connected to the terminal is close to Y1 or Y2.

In the case where each of the segments forming the interconnection stays within the interconnection-allowed region, i.e., in the case where each segment has the opposite ends each defined by the X coordinate from X1′ to X2′ and the Y coordinate from Y1′ to Y2′, detouring portion detecting portion 15 operates to display this segment in an ordinary manner by display device 150. In the case where each of the segments forming the interconnection does not stay within the interconnection-allowed region, i.e., in the case where at least one end of each segment is not defined by the X coordinate from X1′ to X2′ and/or the Y coordinate from Y1′ to Y2′, detouring portion detecting portion 15 operates to display a portion, which stays within the interconnection-allowed region, of the segment in an ordinary manner by display device 150, and to highlight the portion located outside the interconnection-allowed region.

If at least one of the segments forming the interconnection does not stay within the interconnection-allowed region, detour determining portion 16 determines that the interconnection has a detouring form, and displays it by display device 150. When all the segments forming the interconnection stay within the interconnection-allowed region, detour determining portion 16 determines that the interconnection does not have a detouring form, and displays it by display device 150.

(Operation)

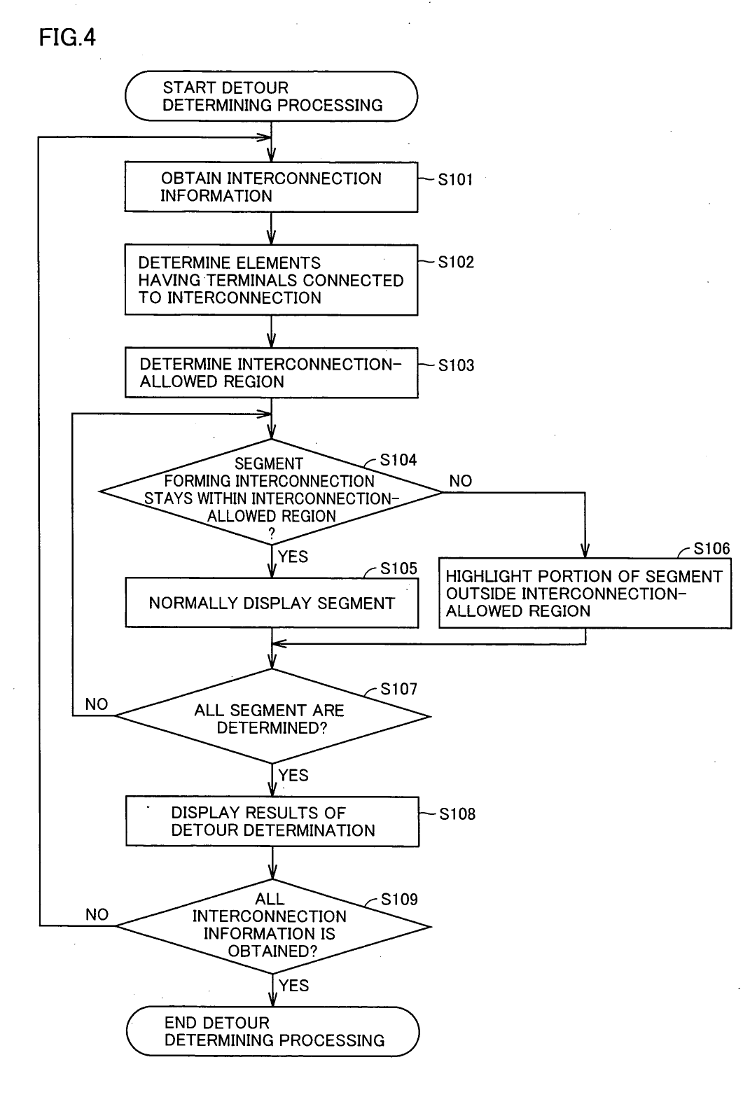

FIG. 4 is a flowchart illustrating operation procedures of the layout verifying system according to this embodiment. Referring to FIG. 4, interconnection information obtaining portion 13 obtains items of the interconnection information one by one. Thus, interconnection information obtaining portion 13 reads one item of the interconnection information from interconnection information storing portion 11, and provides it to interconnection-allowed region determining portion 14 and detouring portion detecting portion 15 (S101).

Then, interconnection-allowed region determining portion 14 determines the element connected to the interconnection. More specifically, interconnection-allowed region determining portion 14 determines the two terminal numbers included in the received interconnection information. Also, interconnection-allowed region determining portion 14 determines the numbers of two elements, which have the terminals bearing the terminal numbers thus determined, respectively, with reference to element information storing portion 12 (S102).

Then, interconnection-allowed region determining portion 14 reads the arrangement information of the two elements bearing the element numbers determined from element information storing portion 12, and determines the interconnection-allowed region based on the interconnection information thus read. More specifically, interconnection-allowed region determining portion 14 reads the arrangement information (XMIN(1), XMAX(1), YMIN(1), YMAX(l)) of the one element and arrangement information (XMIN(2), XMAX(2), YMIN(2), YMAX(2)) of the other element, selects the smaller one between XMIN(1) and XMIN(2) as X1, and selects the larger one between XMAX(1) and XMAX(2) as X2. Also, interconnection-allowed region determining portion 14 selects the smaller one between YMIN(1) and YMIN(2) as Y1, and selects the larger one between YMAX(1) and YMAX(2) as Y2. Interconnection-allowed region determining portion 14 operates based on the relationships of (X1′=(X1−α), X2′=(X2 +α), Y1′=(Y1−α), Y2′=(Y2+α)), determines a region, which is defined by the X coordinate from X1′ to X2′ and the Y coordinate from Y1′ to Y2′, as the interconnection-allowed region, and provides interconnection-allowed region information (X1′, X2′, Y1′, Y2′) representing the region thus determined to detouring portion detecting portion 15 (S103).

Then, detouring portion detecting portion 15 receives the interconnection information and interconnection-allowed region information (X1′, X2′, Y1′, Y2′), and determines whether each of the segments forming the interconnection stays within the interconnection-allowed region or not (S104).

In the case where each of the segments forming the interconnection stays within the interconnection-allowed region, i.e., in the case where each segment has the opposite ends each defined by the X coordinate from X1′ to X2′ and the Y coordinate from Y1′ to Y2′, detouring portion detecting portion 15 operates to display this segment in an ordinary manner by display device 150 (S105).

In the case where each of the segments forming the interconnection does not stay within the interconnection-allowed region, i.e., in the case where at least one end of each segment is not defined by the X coordinate from X1′ to X2′ and/or the Y coordinate from Y1′ to Y2′, detouring portion detecting portion 15 operates to display a portion, which stays within the interconnection-allowed region, of the segment in an ordinary manner by display device 150, and to highlight the portion located outside the interconnection-allowed region (S106).

Detouring portion detecting portion 15 repeats the above operations, and effects the processing in steps S104-S106 on all the segments forming the interconnection (S107).

If at least one of the segments forming the interconnection does not stay within the interconnection-allowed region, detour determining portion 16 determines that the interconnection has a detouring form, and displays it by display device 150. When all the segments forming the interconnection stay within the interconnection-allowed region, detour determining portion 16 determines that the interconnection does not have a detouring form, and displays it by display device 150 (S108).

After the processing in steps S104-S108 is effected on all the segments forming the interconnection, the processing in steps S101-S108 is repeated for the remaining items of the interconnection information (S109).

(Operation Example 1)

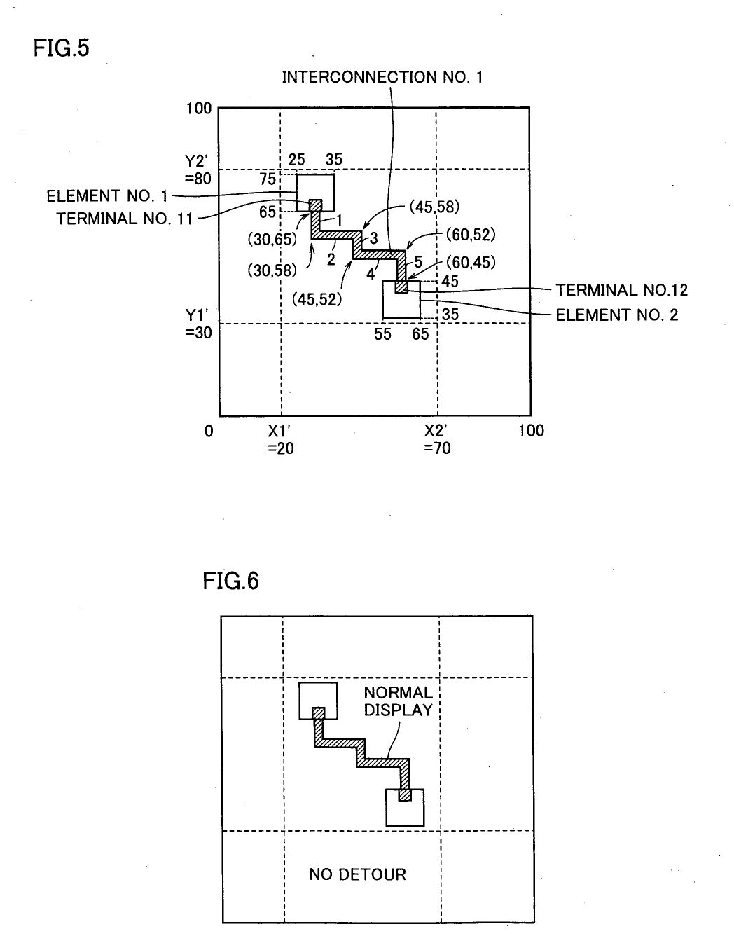

An example of the operation according to this embodiment will now be described. FIG. 5 illustrates a positional relationship between the interconnection information, the arrangement information of the elements connected to the interconnection and the interconnection-allowed region information. As illustrated in FIG. 5, the element of the element number “1” having one terminal connected to the interconnection of the interconnection number “1” provides arrangement information (XMIN(1), XMAX(1), YMIN(1), YMAX(1)) of(25, 35, 65, 75). The element of the element number “2” having the other terminal connected to the interconnection of the interconnection number “1” provides arrangement information (XMIN(2), XMAX(2), YMIN(2), YMAX(2)) of(55, 65, 35, 45).

Assuming that a is equal to 5, the interconnection-allowed region information (X1′, X2′, Y1′, Y2′) is (20, 70, 30, 80).

X coordinate (30) of one end of segment 1 forming the interconnection bearing the interconnection number “1” is in a range from X1′ to X2′, and the Y coordinate (65) thereof is in a range from Y1′ to Y2′. X coordinate (30) of the other end of segment 1 forming the interconnection bearing the interconnection number “1” is in the range from X1′ to X2′, and the Y coordinate (58) thereof is in the range from Y1′ to Y2′.

One end of segment 2 forming the interconnection of the interconnection number “1” is defined by the X coordinate (30) and the Y coordinate (58), which are already described. The X coordinate (45) of the other end of segment 2 forming the interconnection of the interconnection number “1” is in the range from X1′ to X2′, and a Y coordinate (58) thereof is in the range from Y1′ to Y2′.

One end of segment 3 forming the interconnection of the interconnection number “1” is defined by the X coordinate (45) and the Y coordinate (58), which are already described. The X coordinate (45) of the other end of segment 3 forming the interconnection of the interconnection number “1” is in the range from X1′ to X2′, and the Y coordinate (52) thereof is in the range from Y1′ to Y2′.

One end of segment 4 forming the interconnection of the interconnection number “1” is defined by the X coordinate (45) and the Y coordinate (52), which are already described. The X coordinate (60) of the other end of segment 4 forming the interconnection of the interconnection number “1” is in the range from X1′ to X2′, and the Y coordinate (52) thereof is in the range from Y1′ to Y2′.

One end of segment 5 forming the interconnection of the interconnection number “1” is defined by the X coordinate (60) and the Y coordinate (52), which are already described. The X coordinate (60) of the other end of segment 5 forming the interconnection of the interconnection number “1” is in the range from X1′ to X2′, and the Y coordinate (45) thereof is in the range from Y1′ to Y2′.

FIG. 6 shows a layout screen image displayed by display device 150 after determination about the detour. As already described, the opposite ends of each of the segments forming the interconnection of the interconnection number “1” are defined by the X coordinate from X1′ to X2′ and the Y coordinate from Y1′ to Y2′, and all the segments stay within the interconnection-allowed region. Therefore, all the segments forming the interconnection of the interconnection number “1” are displayed normally, and display device 150 displays to the effect that the interconnection does not have a detouring form.

(Operation Example 2)

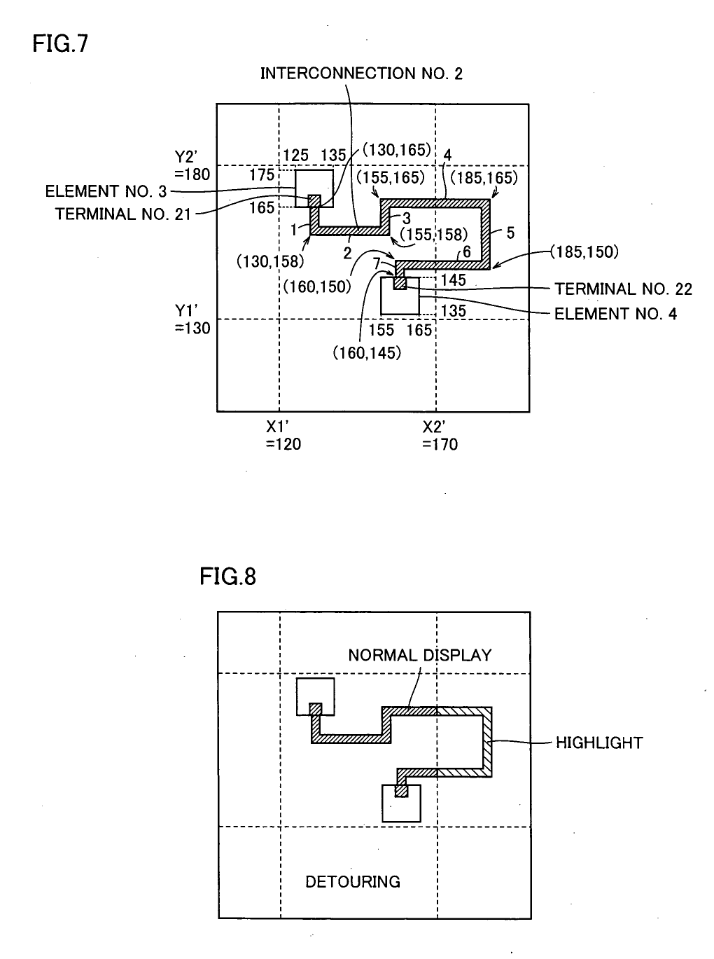

Another example of the operation according to the embodiment will now be described. FIG. 7 illustrates a positional relationship between the interconnection information relating to another interconnection, the arrangement information of the elements connected to this interconnection and the interconnection-allowed region information. As illustrated in FIG. 7, the element of the element number “3” having one terminal connected to the interconnection of the interconnection number “2” provides arrangement information (XMIN(1), XMAX(1), YMIN(1), YMAX(1)) of (125, 135, 165, 175). The element of the element number “4” having the other terminal connected to the interconnection of the interconnection number “1” provides arrangement information (XMIN(2), XMAX(2), YMIN(2), YMAX(2)) of (155, 165, 135, 145).

Assuming that a is equal to 5, the interconnection-allowed region information (X1′, X2′, Y1′, Y2′) is (120, 170, 130, 180).

X coordinate (130) of the one end of segment 1 forming the interconnection of the interconnection number “2” is in the range from X1′ to X2′, and the Y coordinate (165) thereof is in the range from Y1′ to Y2′. X coordinate (130) of the other end of segment 1 forming the interconnection of the interconnection number “2” is in the range from X1′ to X2′, and the Y coordinate (158) thereof is in the range from Y1′ to Y2′.

One end of segment 2 forming the interconnection of the interconnection number “2” is defined by the X coordinate (130) and the Y coordinate (158), which are already described. The X coordinate (155) of the other end of segment 2 forming the interconnection of the interconnection number “2” is in the range from X1′ to X2′, and the Y coordinate (158) thereof is in the range from Y1′ to Y2′.

One end of segment 3 forming the interconnection of the interconnection number “2” is defined by the X coordinate (155) and the Y coordinate (158), which are already described. The X coordinate (155) of the other end of segment 3 forming the interconnection of the interconnection number “2” is in the range from X1′ to X2′, and the Y coordinate (165) thereof is in the range from Y1′ to Y2′.

One end of segment 4 forming the interconnection of the interconnection number “2” is defined by the X coordinate (155) and the Y coordinate (165), which are already described. The X coordinate (185) of the other end of segment 4 forming the interconnection of the interconnection number “2” is not in the range from X1′ to X2′, and the Y coordinate (165) thereof is in the range from Y1′ to Y2′.

One end of segment 5 forming the interconnection of the interconnection number “2” is defined by the X coordinate (185) and the Y coordinate (165), which are already described. The X coordinate (185) of the other end of segment 5 forming the interconnection of the interconnection number “2” is not in the range from X1′ to X2′, and the Y coordinate (150) thereof is in the range from Y1′ to Y2′.

One end of segment 6 forming the interconnection of the interconnection number “2” is defined by the X coordinate (185) and the Y coordinate (150), which are already described. The X coordinate (160) of the other end of segment 6 forming the interconnection of the interconnection number “2” is in the range from X1′ to X2′, and the Y coordinate (150) thereof is in the range from Y1′ to Y2′.

One end of segment 7 forming the interconnection of the interconnection number “2” is defined by the X coordinate (160) and the Y coordinate (150), which are already described. The X coordinate (160) of the other end of segment 7 forming the interconnection of the interconnection number “2” is in the range from X1′ to X2′, and the Y coordinate (145) thereof is in the range from Y1′ to Y2′.

FIG. 8 shows a layout display image displayed by display device 150 after determination about the detour. As already described, the opposite ends of each of the segments 1, 2, 3 and 7 forming the interconnection of the interconnection number “2” are defined by the X coordinates in the range from X1′ to X2′ and the Y coordinates in the range from Y1′ to Y2′, and all the segments 1, 2, 3 and 7 stay within the interconnection-allowed region so that these segments are displayed normally. However, at least one of the opposite ends of each of segments 4, 5 and 6 is not defined by the X coordinate from X1′ to X2′, and/or is not defined the Y coordinate from Y1′ to Y2′. These segments 4, 5 and 6 do not stay within the interconnection-allowed region so that portions of these segments located within the interconnection-allowed region are normally displayed, and portions outside the interconnection-allowed region are highlighted.

Since one or more segments forming the interconnection of the interconnection number “2” do not stay within the interconnection-allowed region, display device 150 displays to that effect that the interconnection has a detouring form.

As described above, layout verifying device 100 of the embodiment determines whether each of the segments forming the interconnection stays within the interconnection-allowed region defined according to the position of the element connected to the interconnection or not, and thereby can easily perform the determination about the detouring of the interconnections.

[Second Embodiment]

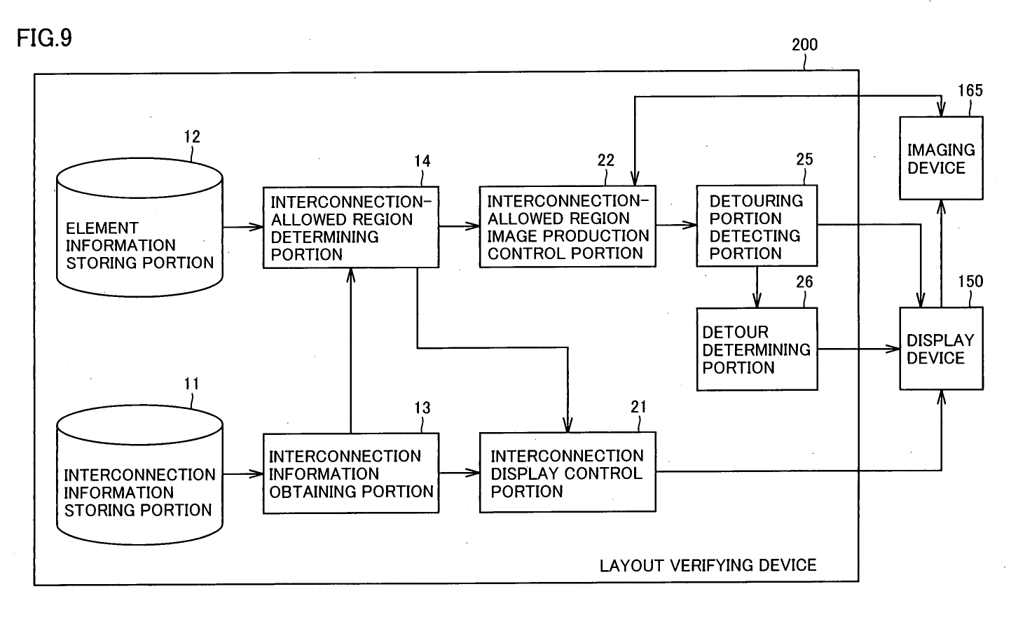

FIG. 9 shows a structure of a layout verifying system according to a second embodiment. Referring to FIG. 9, this layout verifying system includes a layout verifying device 200, an imaging device 165 and display device 150. Layout verifying device 200 includes interconnection information storing portion 11, element information storing portion 12, interconnection information obtaining portion 13, interconnection-allowed region determining portion 14, an interconnection display control portion 21, an interconnection-allowed region image production control portion 22, a detouring portion detecting portion 25 and a detour determining portion 26. In FIG. 9, the same components as those of the layout verifying system shown in FIG. 1 bear the same reference numbers. The following description will be given on the components, which are not included in the layout verifying system shown in FIG. 1.

Interconnection display control portion 21 receives the interconnection information sent from interconnection information obtaining portion 13 and the element information sent from interconnection-allowed region determining portion 14, and controls display device 150 to display the interconnections and elements based on the received information.

Interconnection-allowed region image production control portion 22 operates based on the received interconnection-allowed region information (X1′, X2′, Y1′, Y2′) to control imaging device 165 to produce the interconnection-allowed region image by taking a picture of the interconnection-allowed region on display device 150, and obtains the interconnection-allowed region image thus produced.

Imaging device 165 takes a picture of the interconnection-allowed region within display device 150 to produce the interconnection-allowed region image. This interconnection-allowed region image is a binary image, in which the pixel representing the interconnection takes the value of “1”, and the pixel representing the background takes the value of “0”.

Detouring portion detecting portion 25 determines whether the pixels of the value “1” continuously appear in the interconnection-allowed region image or not, and thereby determines whether the interconnection has a detouring form or not. More specifically, detouring portion detecting portion 25 determines whether the pixels of pixel value “1” continuously appear to form a single segment, or discontinuously appears to form a plurality of segments. When the pixels of pixel value “1” discontinuously appear in the interconnection-allowed region image, and form the plurality of segments, detour determining portion 26 highlights a region of a certain size including the discontinuous segments.

When the pixels of pixel value “1” continuously appear in the interconnection-allowed region image to form the single segment, detour determining portion 26 determines that the interconnection in question does not have a detouring form, and displays it by display device 150. When the pixels of pixel value “1” discontinuously appear in the interconnection-allowed region image to form the plurality of segments, detour determining portion 26 determines that the interconnection in question has a detouring form, and displays it by display device 150.

(Operation)

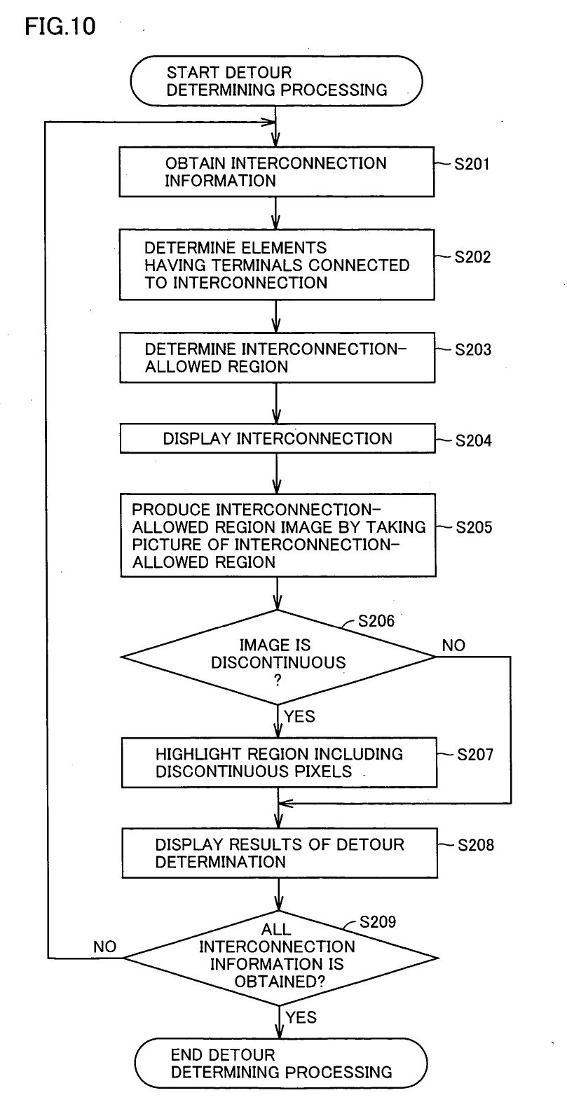

FIG. 10 is a flowchart illustrating operation procedures of the layout verifying system according to the embodiment. Referring to FIG. 10, interconnection information obtaining portion 13 obtains the items of interconnection information one by one, similarly to the first embodiment. Thus, interconnection information obtaining portion 13 reads one item of the interconnection information from interconnection information storing portion 11, and provides it to interconnection-allowed region determining portion 14 and interconnection display control portion 21 (S201).

Similarly to the first embodiment, interconnection-allowed region determining portion 14 determines the element having the terminal connected to the interconnection. More specifically, interconnection-allowed region determining portion 14 determines the two terminal numbers included in the received interconnection information. Interconnection-allowed region determining portion 14 determines the two element numbers of the elements having the terminals of the terminal numbers determined from the information in element information storing portion 12 (S202).

Then, interconnection-allowed region determining portion 14 reads the arrangement information of the elements of the two element numbers determined from the information in element information storing portion 12, and determines the interconnection-allowed region based on the interconnection information thus read, similarly to the first embodiment. More specifically, interconnection-allowed region determining portion 14 reads the arrangement information (XMIN(1), XMAX(1), YMIN(1), YMAX(1)) of one of the elements and the arrangement information (XMIN(2), XMAX(2), YMIN(2), YMAX(2)) of the other element, selects smaller one between XMIN(1) and XMIN(2) as X1, selects larger one between XMAX(1) and XMAX(2) as X2, selects smaller one between YMIN(1) and YMIN(2) as Y1, and selects larger one between YMAX(1) and YMAX(2) as Y2. Interconnection-allowed region determining portion 14 operates based on the relationships of (X1′=(X1−α), X2′=(X2+α), Y1′=(Y1−α), Y2′=(Y2 +α)), determines the region, which is defined by the X coordinate from X1′ to X2′ and the Y coordinate from Y1′ to Y2′, as the interconnection-allowed region, and provides the interconnection-allowed region information (X1′, X2′, Y1′, Y2′) representing the region thus determined to interconnection-allowed region image production control portion 22. Interconnection-allowed region determining portion 14 provides the arrangement information of the two elements to interconnection display control portion 21 (S203).

Based on the received interconnection information and the element information, interconnection display control portion 21 controls display device 150 to display the interconnections and the elements (S204).

Then, based on the received interconnection-allowed region information (X1′, X2′, Y1′, Y2′), interconnection-allowed region image production control portion 22 controls imaging device 165 to produce the interconnection-allowed region image by taking a picture of the interconnection-allowed region on display device 150, and obtains the interconnection-allowed region image thus produced (S205).

Then, detouring portion detecting portion 25 determines whether the pixels of pixel value “1” continuously appear in the interconnection-allowed region image or not, and thereby determines whether the interconnection has a detouring form or not. Thus, detouring portion detecting portion 25 determines whether the pixels of pixel value “1” continuously appear to form a single segment, or discontinuously appear to form a plurality of segments (S206).

When the pixels of pixel value “1” discontinuously appear in the interconnection-allowed region image, and form the plurality of segments, detour determining portion 26 highlights a region including the discontinuous segments (S207).

When the pixels of pixel value “1” continuously appear in the interconnection-allowed region image to form the single segment, detour determining portion 26 determines that the interconnection in question does not have a detouring form, and displays it by display device 150. When the pixels of pixel value “1” discontinuously appear in the interconnection-allowed region image to form the plurality of segments, detour determining portion 26 determines that the interconnection in question has a detouring form, and displays it by display device 150 (S208).

The processing in S201-S208 is repeated to process the remaining interconnection information (S209).

(Operation Example)

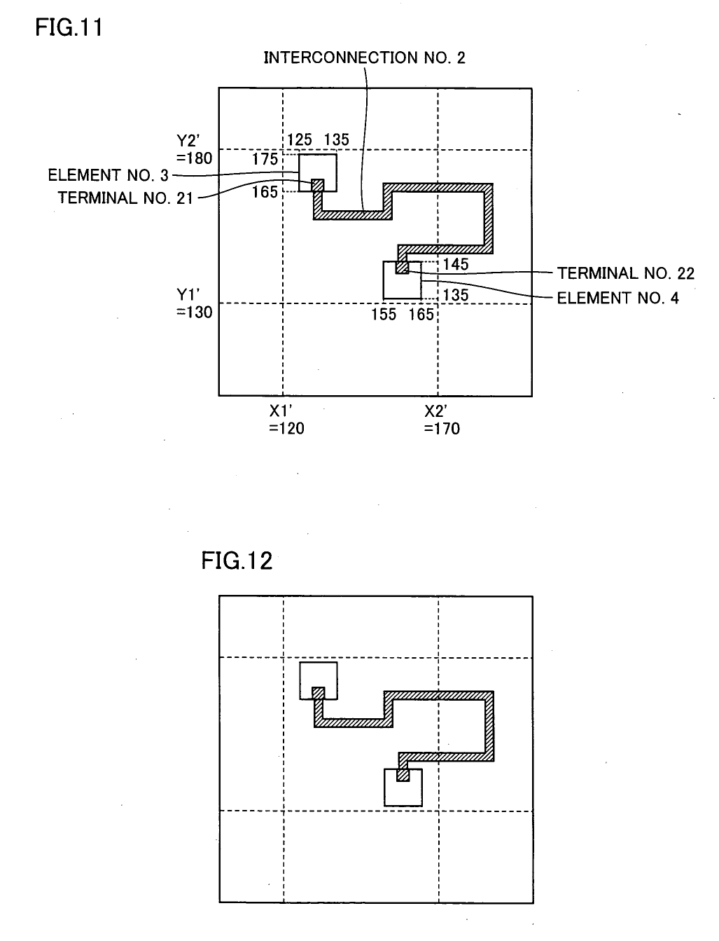

An example of the operation according to the embodiment will now be described. FIG. 11 illustrates a positional relationship between the interconnection information, the arrangement information of the elements connected to the interconnection and the interconnection-allowed region information: As illustrated in FIG. 11, the element of the element number “3” having one terminal connected to the interconnection of the interconnection number “2” provides arrangement information (XMIN(1), XMAX(1), YMIN(1), YMAX(1)) of(125, 135, 165, 175). The element of the element number “4” having the other terminal connected to the interconnection of the interconnection number “1” provides arrangement information (XMIN(2), XMAX(2), YMIN(2), YMAX(2)) of (155, 165, 135, 145).

Assuming that a is equal to 5, the interconnection-allowed region information (X1′, X2′, Y1′, Y2′) is (120, 170, 130, 180).

FIG. 12 shows a layout screen image of the interconnection and the elements displayed by display device 150 controlled by interconnection display control portion 21. FIG. 12 shows the interconnection of the interconnection number “2” and the elements of the element numbers “3” and “4”.

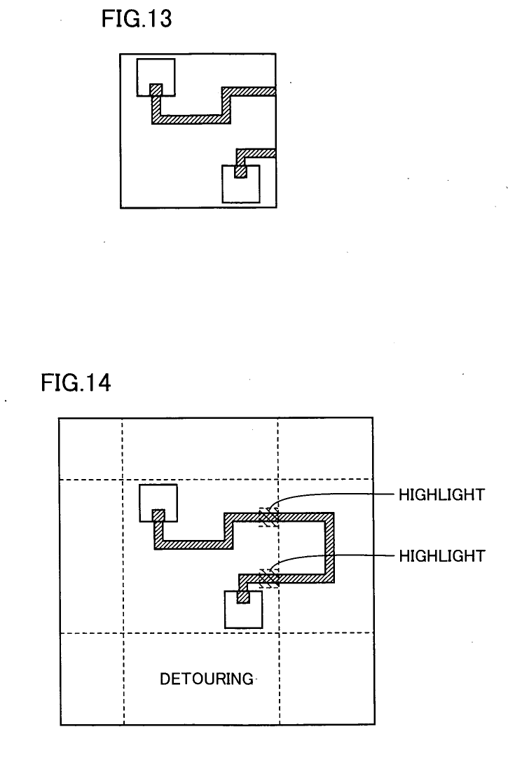

FIG. 13 shows an interconnection-allowed region image produced by imaging device 165 controlled by interconnection-allowed region image production control portion 22. As shown in FIG. 13, the image of the interconnection-allowed region shown in FIG. 12 is produced.

FIG. 14 shows a layout screen image displayed by display device 150 after determination about the detour. As shown in FIG. 14, the pixels of the pixel value “1” discontinuously appear in the interconnection-allowed region image to form two segments. Therefore, display device 150 highlights regions including the discontinuous pixels, and displays to the effect that the interconnection has a detouring form.

According to layout verifying device 200 of this embodiment, as described above, the interconnection-allowed region image is produced by taking a picture of the interconnection-allowed region, which is determined based on the position of the element connected to the interconnection, and detouring and non-detouring of the interconnection can be easily determined based on whether the pixels continuously appear in the interconnection-allowed region image or not.

[Third Embodiment]

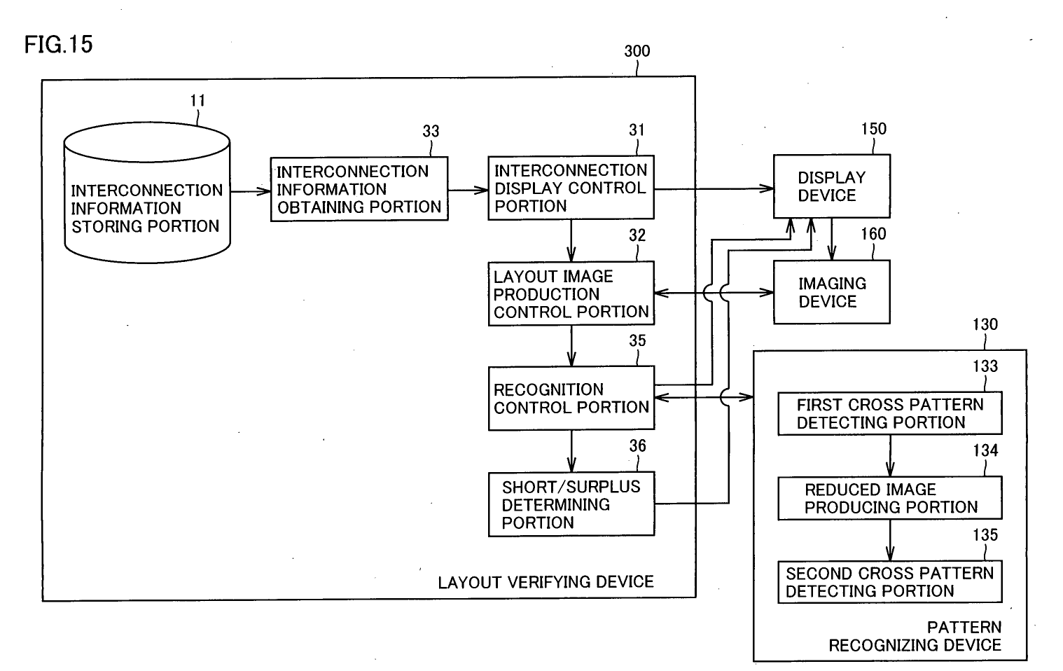

FIG. 15 shows a structure of a layout verifying system according to a third embodiment. Referring to FIG. 15, the layout verifying system includes a layout verifying device 300, an imaging device 160, display device 150 and a pattern recognizing device 130. Layout verifying device 300 includes interconnection information storing portion 11, an interconnection information obtaining portion 33, an interconnection display control portion 31, a layout image production control portion 32, a recognition control portion 35 and a short/surplus determining portion 36. Pattern recognizing device 130 includes a first cross pattern detecting portion 133, a reduced image producing portion 134 and a second cross pattern detecting portion 135.

In FIG. 15, the same components as those of the layout verifying systems shown in FIGS. 1 and 9 bear the same reference numbers. Description will now be given on the components, which are not included in the layout verifying systems in FIGS. 1 and 9.

Interconnection information obtaining portion 33 reads all the interconnection information or a predetermined number of items of the interconnection information from interconnection information storing portion 11, and provides the read information or items to interconnection display control portion 31.

Interconnection display control portion 31 controls display device 150 to display the interconnection based on the received interconnection information.

Layout image production control portion 32 controls imaging device 160 to produce the layout image by taking a picture of the screen of display device 150 displaying the interconnection, and obtains the layout image.

Imaging device 160 takes the picture of the screen of display device 150 displaying the interconnection, and produces the layout image. This layout image is a binary image, in which the pixels of value “1” represent the interconnection, and the pixels of value “0” represent the background. The layout image is displayed in such resolutions that the displayed interconnection has a line width of one pixel.

Recognition control portion 35 controls pattern recognizing device 130 to perform primary detection processing. More specifically, recognition control portion 35 controls pattern recognizing device 130 to determine whether a cross pattern is present in each of blocks, which are defined by dividing the layout image and each have a size of 3 pixels by 3 pixels, or not. Recognition control portion 35 controls pattern recognizing device 130 to perform secondary detection processing. More specifically, recognition control portion 35 determines whether a cross pattern is present in an arbitrary region, which has a size of 3-by-3 blocks and includes a block not containing the cross pattern and the blocks neighboring to it, or not. When recognition control portion 35 detects the cross pattern, i.e., when it receives the coordinates of the pixels forming the cross pattern, display device 150 highlights the pixels forming the cross pattern.

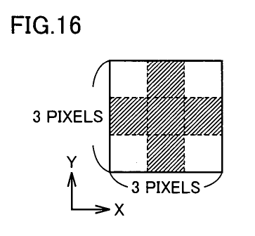

First cross pattern detecting portion 133 divides the layout image into blocks each having a size of 3-by-3 blocks. First cross pattern detecting portion 133 determines whether the cross pattern is present in each block or not, and thus whether the pattern of pixels in each block is the cross pattern as shown in FIG. 16 or not. When first cross pattern detecting portion 133 detects the cross pattern, it sends the coordinate of the pixels forming the detected cross pattern to recognition control portion 35.

Reduced image producing portion 134 produces a reduced layout image from the layout image by reducing each of the resolutions in the X-axis direction and the Y-axis direction by a factor of three. Thus, reduced image producing portion 134 reduces the block of 3-by-3 pixels in the layout image to one pixel. The value of the pixel thus produced takes the value of “1” if the block of 3-by-3 pixels contains at least one pixel of a value “1”, and takes the value of “0” if all the pixels in the original block take the value of “0”.

Second cross pattern detecting portion 135 determines whether an arbitrary region of 3-by-3 pixels contains the cross pattern as shown in FIG. 16 or not. However, this determination is not effected on the region of 3-by-3 pixels containing at its center the pixel, which is produced by reducing the block containing the cross pattern detected by the first cross pattern detecting portion 133. When the region of 3-by-3 pixels contains the cross pattern, cross pattern detecting portion 135 specifies the pixels forming the detected cross pattern, determines the block in the original layout image corresponding to the pixels thus specified, and sends the coordinates of the pixels of “1” in the determined block to recognition control portion 35.

When recognition control portion 35 receives the coordinates of the pixels from pattern recognizing device 130, i.e., when first or second cross pattern detecting portion 133 or 135 detects the cross pattern, short/surplus determining portion 36 determines that the interconnection in the layout image has a short-circuited portion or a surplus portion, and display device 150 displays to that effect. When recognition control portion 35 does not receive any coordinate of the pixel from pattern recognizing device 130, i.e., when neither first cross pattern detecting portion 133 nor second cross pattern detecting portion 135 detects the cross pattern, short/surplus determining portion 36 determines that the interconnection in the layout image has neither a short-circuited portion nor a surplus portion, and display device 150 displays to that effect.

(Operation)

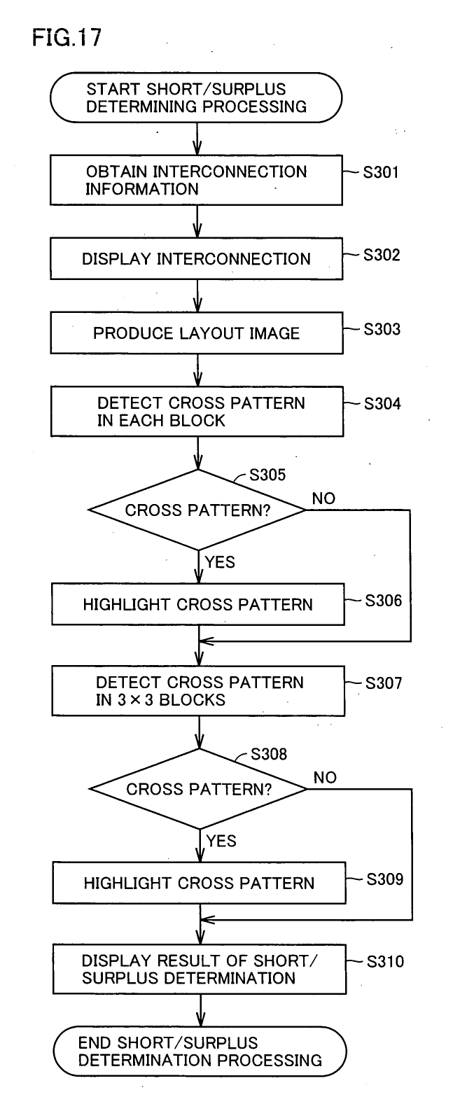

FIG. 17 is a flowchart illustrating operation procedures of the layout verifying system according to the embodiment. Referring to FIG. 17, interconnection information obtaining portion 33 obtains all the interconnection information or a predetermined number of items of the interconnection information. Thus, interconnection information obtaining portion 33 reads all the interconnection information or the predetermined number of items of the interconnection information from interconnection information storing portion 11, and provides it to interconnection display control portion 31 (S301).

Then, interconnection display control portion 31 displays the interconnection by display device 150 based on the received interconnection information (S302).

Layout image production control portion 32 controls imaging device 160 to produce the layout image by taking a picture of the screen of display device 150 displaying the interconnection, and obtains the layout image. It is now assumed that imaging device 160 produces the layout image in such resolutions that the displayed interconnection has a line width of one pixel (S303).

Then, recognition control portion 35 controls pattern recognizing device 130 to perform the primary detection processing. More specifically, recognition control portion 35 controls pattern recognizing device 130 to determine whether a cross pattern is present in each of blocks, which are defined by dividing the layout image and each have a size of 3-by-3 pixels. First cross pattern detecting portion 133 in pattern recognizing device 130 divides the layout image into blocks each having the size of 3-by-3 pixels. First cross pattern detecting portion 133 determines whether each block contains a cross pattern or not, and thus, whether the pixel pattern of each block is the cross pattern as shown in FIG. 16 or not. When first cross pattern detecting portion 133 detects the cross pattern, it sends the coordinates of the pixels forming the detected cross pattern to recognition control portion 35 (S304).

When the cross pattern is detected, and thus when recognition control portion receives the coordinates of the pixels forming the cross pattern, it controls display device 150 to highlight the pixels forming the cross pattern (S305, S306).

Then recognition control portion 35 controls pattern recognizing device 130 to perform the secondary detection processing. More specifically, recognition control portion 35 controls pattern recognizing device 130 to determine whether the cross pattern is present in the region of 3-by-3 blocks including the block not containing the cross pattern and the blocks neighboring to it, or not. Reduced image producing portion 134 in pattern recognizing device 130 produces a reduced layout image by reducing the resolutions of the layout image in the X- and Y-axis directions by a factor of three. Thus, reduced image producing portion 134 reduces the block of 3-by-3 pixels in the layout image to one pixel. The one pixel thus produced takes the value of “1” if the original block contains at least one pixel of “1”, and takes the value of “0” if all the pixels in the original block take the value of “0”.

Second cross pattern detecting portion 135 of pattern recognizing device 130 determines whether an arbitrary region of 3-by-3 pixels contains the cross pattern as shown in FIG. 16 or not. However, this determination is not effected on the region of 3-by-3 pixels containing at its center the pixel, which is produced by reducing the block containing the cross pattern detected in step S305. When the region of 3-by-3 pixels contains the cross pattern, cross pattern detecting portion 135 specifies the pixels forming the detected cross pattern, determines the block in the original layout image corresponding to the pixels thus specified, and sends the coordinates of the pixels of “1” in the determined block to recognition control portion 35 (S307).

When the cross pattern is detected, i.e., when recognition control portion 35 receives the coordinates of the pixels forming the cross pattern, it controls display device 150 to highlight the pixels forming the cross pattern (S308 and S309).

When recognition control portion 35 receives the coordinates of the pixels from pattern recognizing device 130, i.e., when first or second cross pattern detecting portion 133 or 135 detects the cross pattern, short/surplus determining portion 36 determines that the interconnection in the layout image has a short-circuited portion or a surplus portion, and display device 150 displays to that effect. When recognition control portion 35 does not receive the coordinate of any pixel from pattern recognizing device 130, i.e., when neither first cross pattern detecting portion 133 nor second cross pattern detecting portion 135 detects the cross pattern, short/surplus determining portion 36 determines that the interconnection in the layout image has neither a short-circuited portion nor a surplus portion, and display device 150 displays to that effect (S310).

(Operation Example)

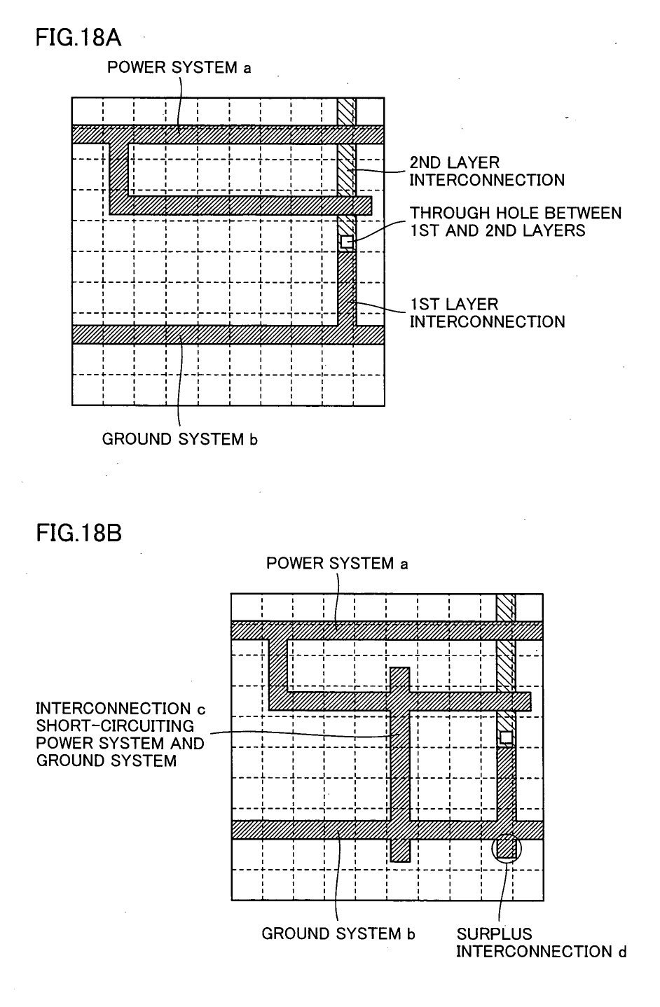

An example of the operation according to this embodiment will now be described. FIG. 18A shows an ideal layout of the interconnections. As shown in FIG. 18A, an interconnection a of a power supply system and an interconnection b of a ground system are arranged in a first layer.

FIG. 18B shows a layout of the interconnections after a layout designing stage. As shown in FIG. 18B, the layout includes an interconnection c short-circuiting interconnection a of the power supply system and interconnection b of the ground system, and also includes a surplus interconnection d.

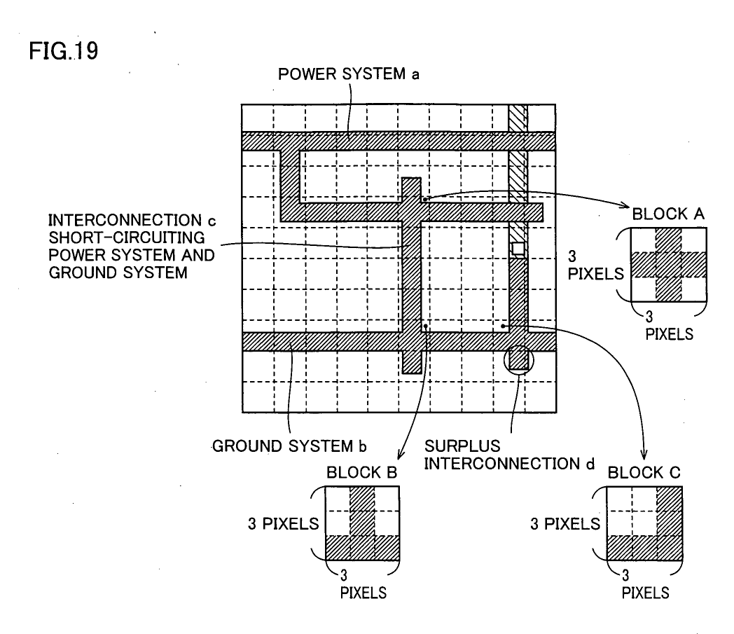

FIG. 19 shows blocks in the interconnection layout shown in FIG. 18B, and particularly shows a block containing a cross pattern, which is detected by the primary detection processing of pattern recognizing device 130, and blocks not containing the cross pattern to be detected by such detection processing. As shown in FIG. 19, the interconnections cross each other in and/or near blocks A, B and C.

Since block A contains the cross pattern as shown in FIG. 16, first cross pattern detecting portion 133 detects block A. Block B does not contain a cross pattern, but contains a T-shaped pattern. This is because the pixels in block B form a cross pattern together with the pixels in the neighboring block. Therefore, first cross pattern detecting portion 133 does not detect the cross pattern in block B. Block C does not contain a cross pattern, but contains an L-shaped pattern. This is because the pixels in block C form a cross pattern together with the pixels in the neighboring block. Therefore, first cross pattern detecting portion 133 does not detect the cross pattern in block C.

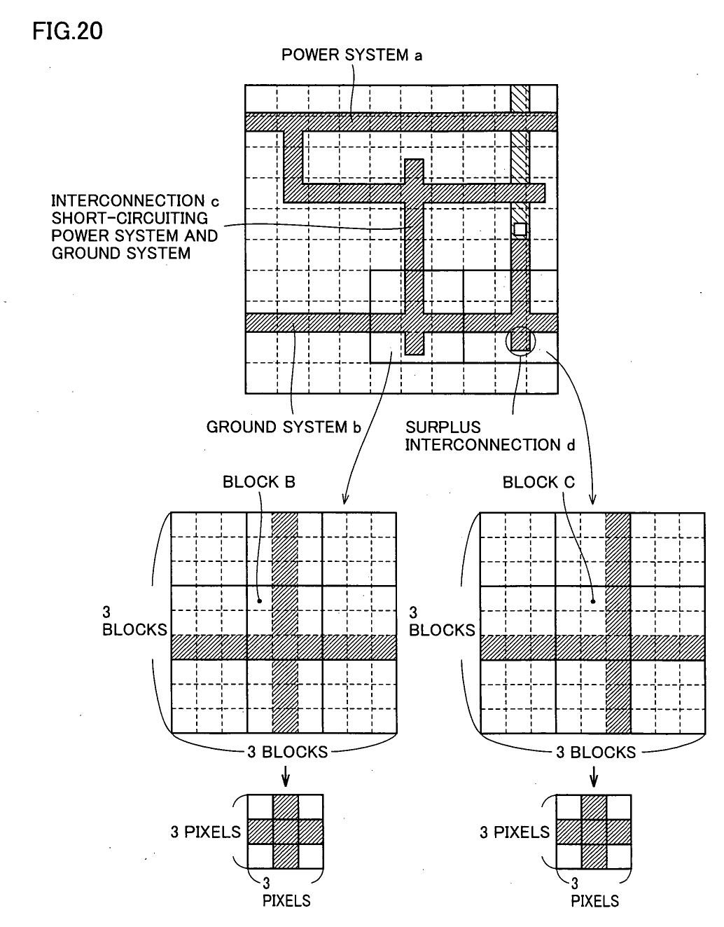

FIG. 20 shows block groups in the interconnection layout shown in FIG. 18B, and particularly shows the block groups, in which the cross patterns are detected by the secondary detection processing of pattern recognizing device 130, respectively. Referring to FIG. 20, the cross pattern is detected in the block group of 3-by-3 blocks formed of block B and eight blocks neighboring to block B. This is for the following reasons. Since all the pixels in each of the upper left, lower left, upper right and lower right blocks belonging to the above block group take the values of “0”, these blocks are reduced to the pixels of pixel values of “0”, respectively. Other blocks contain the pixels of pixel values of “1”, and therefore are reduced to the pixels of pixel values of “1”, respectively. The pixel group of 3-by-3 pixels thus produced contains the cross pattern. Therefore, the cross pattern is detected in the block group as described above.

Also, the cross pattern is detected in the block group of 3-by-3 blocks formed of block C and eight blocks neighboring to block C. This is for the following reasons. Since all the pixels in each of the upper left, lower left, upper right and lower right blocks belonging to the above block group take the values of “0”, these blocks are reduced to the pixels of pixel values of “0”, respectively. Other blocks contain the pixels of pixel values of “1”, and therefore are reduced to the pixels of pixel values of “1”, respectively. The pixel group of 3-by-3 pixels thus produced contains the cross pattern. Therefore, the cross pattern is detected in the block group as described above.

As described above, layout verifying device 300 of the embodiment divides the layout image into the blocks, and determines whether each block or each block group of 3-by-3 blocks contains the cross pattern or not so that the presence of the short circuit and the surplus portion can be easily determined with high reliability.

[Fourth Embodiment]

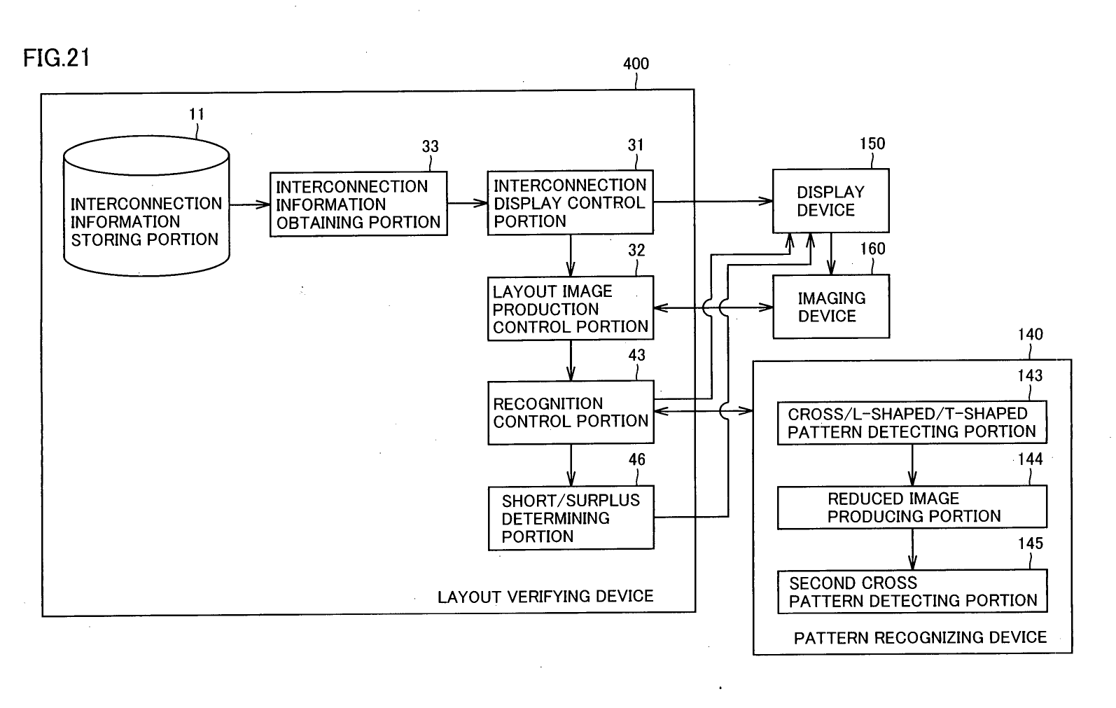

FIG. 21 shows a layout verifying system according to a fourth embodiment. Referring to FIG. 21, this layout verifying system includes a layout verifying device 400, imaging device 160, display device 150 and a pattern recognizing device 140. Layout verifying device 400 includes interconnection information storing portion 11, interconnection information obtaining portion 33, interconnection display control portion 31, layout image production control portion 32, a recognition control portion 43 and a short/surplus determining portion 46. Pattern recognizing device 140 includes a cross/L-shaped/T-shaped pattern detecting portion 143, a reduced image producing portion 144 and a second cross pattern detecting portion 145.

In FIG. 21, the same components as those of the layout verifying systems shown in FIGS. 1, 9 and 15 bear the same reference numbers. Description will now be given on the components, which are not included in the layout verifying systems in FIGS. 1, 9 and 15.

Recognition control portion 43 controls pattern recognizing device 140 to perform the primary detection processing. More specifically, recognition control portion 43 controls pattern recognizing device 140 to determine whether a cross, L-shaped or T-shaped pattern is present in blocks, which are defined by dividing the layout image and each have a size of 3-by-3 pixels, or not.

When the cross pattern is detected, i.e., when recognition control portion 43 receives the coordinates of the pixels forming the cross pattern, it controls display device 150 to highlight the pixels forming the cross pattern displayed thereby.

When the L- or T-shaped pattern is detected, i.e., when recognition control portion 43 receives a block number indicating a block, it controls pattern recognizing device 140 to perform the secondary detection processing. Thus, recognition control portion 43 controls pattern recognizing device 140 to determine whether a cross pattern is present in a block group of 3-by-3 blocks including the block bearing the received block number and the blocks neighboring to it.

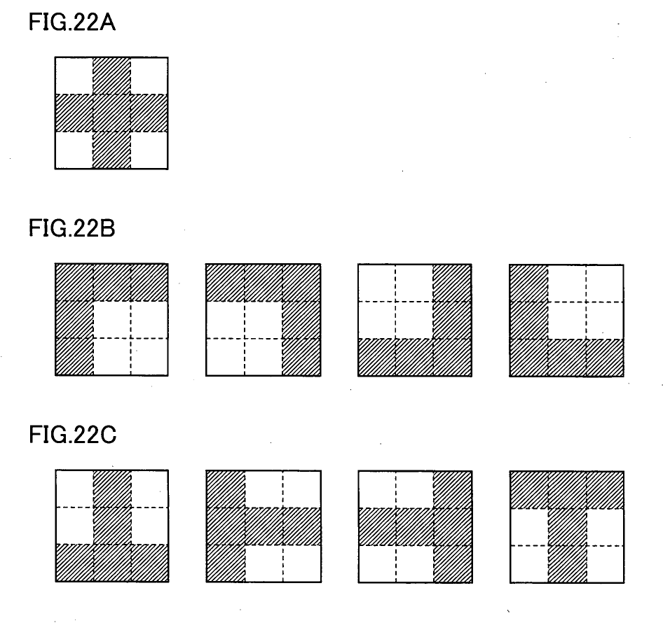

Cross/L-shaped/T-shaped pattern detecting portion 143 divides the layout image into blocks each formed of 3-by-3 pixels. Cross/L-shaped/T-shaped pattern detecting portion 143 determines whether the pixel pattern in each block is a cross pattern shown in FIG. 22A, an L-shaped pattern shown in FIG. 22B, a T-shaped pattern shown in FIG. 22C or another pattern. When the cross pattern is detected, cross/L-shaped/T-shaped pattern detecting portion 143 sends the coordinates of the pixels forming the detected cross pattern to recognition control portion 43. When the L- or T-shaped pattern is detected, cross/L-shaped/T-shaped pattern detecting portion 143 sends the number indicating the block containing the detected pattern to recognition control portion 43.

Reduced image producing portion 144 produces a reduced image formed of 3-by-3 pixels from designated 3-by-3 blocks by reducing the resolutions in the X- and Y-axis directions by a factor of three. Thus, reduced image producing portion 144 reduces the block of 3-by-3 pixels to one pixel. If the block contains at least one pixel of a value “1”, the pixel formed by the reduction takes a value of “1”. If all the pixels in the block take values of “0”, the pixel formed by the reduction takes a value of “0”.

Second cross pattern detecting portion 145 determines whether the reduced image contains a cross pattern as shown in FIG. 22A. If the reduced image contains the cross pattern, cross pattern detecting portion 145 specifies the pixels forming the cross pattern, determines the block in the layout image corresponding to the pixels thus specified, and sends the coordinates of the pixels of “1” in the block thus determined to recognition control portion 43.

When recognition control portion 43 receives the coordinates of the pixels from pattern recognizing device 140, i.e., when either cross/L-shaped/T-shaped pattern detecting portion 143 or second cross pattern detecting portion 145 detects the cross pattern, short/surplus determining portion 46 determines that the interconnection in the layout image contains a short-circuited portion or a surplus portion, and display device 150 displays to that effect. When recognition control portion 43 does not receive coordinates of any pixel from pattern recognizing device 140, i.e., when neither cross/L-shaped/T-shaped pattern detecting portion 143 nor second cross pattern detecting portion 145 detects the cross pattern, short/surplus determining portion 46 determines that the interconnection in the layout image contains neither a short-circuited portion nor a surplus portion, and display device 150 displays to that effect.

(Operation)

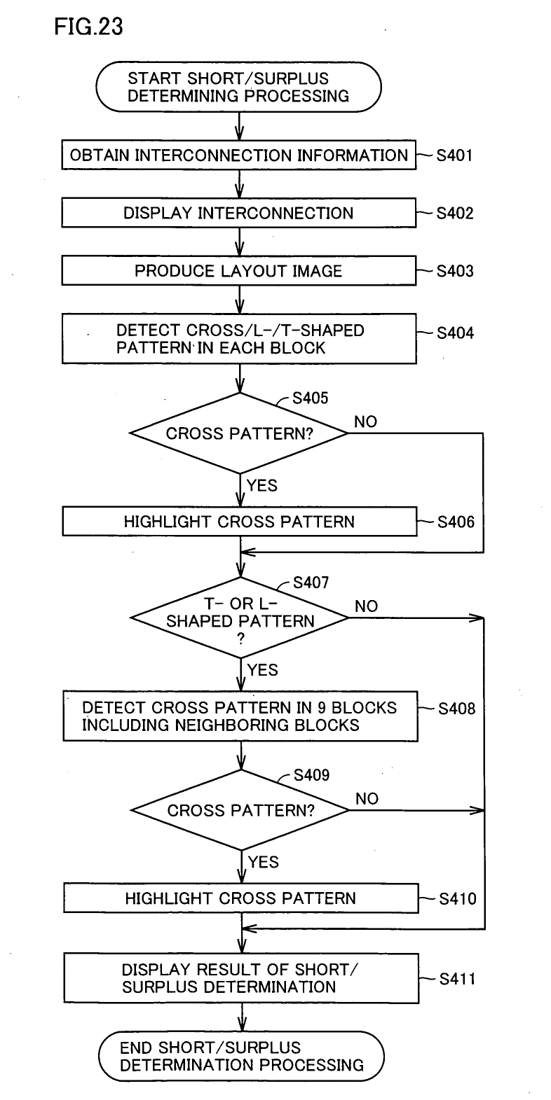

FIG. 23 is a flowchart illustrating operation procedures of the layout verifying system according to this embodiment. Referring to FIG. 23, interconnection information obtaining portion 33 obtains the interconnection information, similarly to the third embodiment. Interconnection information obtaining portion 33 reads the interconnection information from interconnection information storing portion 11, and provides it to interconnection display control portion 31 (S401).

Similarly to the third embodiment, interconnection display control portion 31 then controls display device 150 to display the interconnections based on the received interconnection information (S402).

Similarly to the third embodiment, layout image production control portion 32 controls imaging device 160 to produce a layout image by taking a picture of a portion including the interconnections on the screen of display device 150, and obtains the layout image. It is assumed that imaging device 160 produces the layout image in such resolutions that the displayed interconnection has a line width of one pixel (S403).

Then, recognition control portion 43 controls pattern recognizing device 140 to perform the primary detection processing. More specifically, recognition control portion 43 controls pattern recognizing device 140 to determine whether a cross, L-shaped or T-shaped pattern is present in each of the blocks, which are defined by dividing the layout image and each have a size of 3-by-3 pixels. Cross/L-shaped/T-shaped pattern detecting portion 143 of pattern recognizing device 140 divides the layout image into blocks each having a size of 3-by-3 pixels. Cross/L-shaped/T-shaped pattern detecting portion 143 determines whether the pattern of pixels in each block is the cross pattern shown in FIG. 22A, L-shaped pattern shown in FIG. 22B, T-shaped pattern shown in FIG. 22C or another pattern. When cross/L-shaped/T-shaped pattern detecting portion 143 detects the cross pattern, it sends the coordinates of the pixels forming the cross pattern to recognition control portion 43. When cross/L-shaped/T-shaped pattern detecting portion 143 detects the L- or T-shaped pattern, it sends the number indicating the block to recognition control portion 43 (S404).

When the cross pattern is detected, i.e., when recognition control portion 43 receives the coordinates of the pixels forming the cross pattern, display device 150 highlights the pixels forming the cross pattern (S405 and S406).

When the L- or T-shaped pattern is detected, i.e., when recognition control portion. 43 receives the block number indicating the block, it controls pattern recognizing device 140 to perform the secondary detection processing. Thus, recognition control portion 43 controls pattern recognizing device 140 to determine whether the cross pattern is present in the region of 3-by-3 blocks formed of the block bearing the received block number and eight blocks neighboring to it. Reduced image producing portion 144 of pattern recognizing device 140 produces the reduced image formed of 3-by-3 pixels from the foregoing 3-by-3 blocks by reducing the resolutions in the X- and Y-axis directions by a factor of three. Thus, reduced image producing portion 144 reduces the block formed of 3-by-3 pixels to one pixel. If the block includes at least one pixel taking the value of “1”, the one pixel thus produced takes the pixel value of “1”. If all the pixels in the block take the values of “0”, the one pixel thus produced takes the value of “0”.

Then, second cross pattern detecting portion 145 of pattern recognizing device 140 determines whether the reduced image contains the cross pattern as shown in FIG. 22A. When the reduced image contains the cross pattern, cross pattern detecting portion 145 specifies the pixels forming the detected cross pattern, determines the block in the original layout image corresponding to the pixels thus specified, and sends the coordinates of the pixels of “1” in the determined block to recognition control portion 43 (S407 and S408).

When the cross pattern is detected, i.e., when recognition control portion 43 receives the coordinates of the pixels forming the cross pattern, it controls display device 150 to highlight the pixels forming the cross pattern (S409 and S410).

When recognition control portion 43 receives the coordinates of the pixels from pattern recognizing device 140, i.e., when either cross/L-shaped/T-shaped pattern detecting portion 143 or second cross pattern detecting portion 145 detects the cross pattern, short/surplus determining portion 46 determines that the interconnection in the layout image has a short-circuited portion or a surplus portion, and display device 150 displays to that effect. When recognition control portion 43 does not receive the coordinate of any pixel from pattern recognizing device 140, i.e., when neither cross/L-shaped/T-shaped pattern detecting portion 143 nor second cross pattern detecting portion 145 detects the cross pattern, short/surplus determining portion 46 determines that the interconnection in the layout image has neither a short-circuited portion nor a surplus portion, and display device 150 displays to that effect (S411).

(Operation Example)

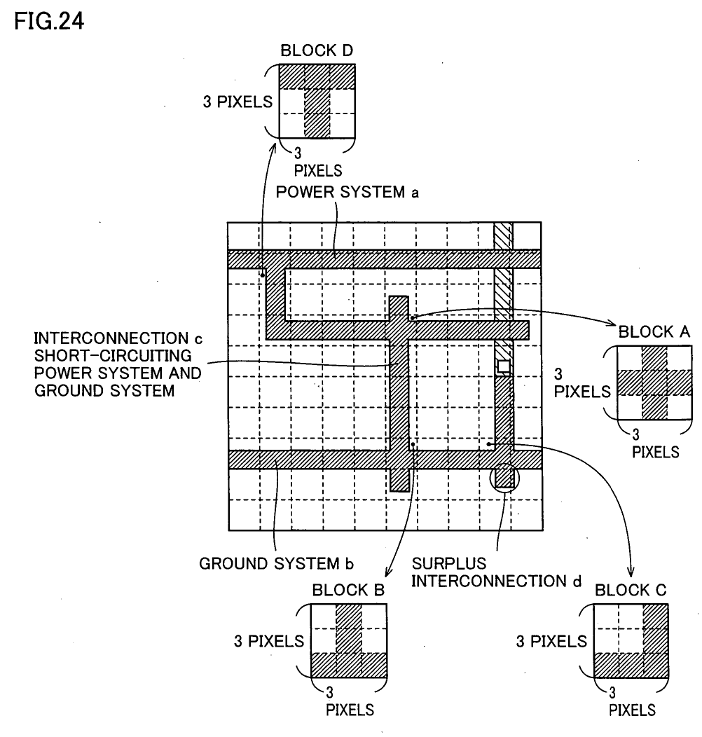

An example of the operation according to this embodiment will now be described. FIG. 24 shows some blocks in the layout of the interconnections shown in FIG. 18B, and particularly shows blocks, in which a cross pattern, an L-shaped pattern and T-shaped patterns are detected by the primary detection processing of pattern recognizing device 140, respectively. As shown in FIG. 24, block A includes a cross pattern shown in FIG. 22A, and this pattern is detected by cross/L-shaped/T-shaped pattern detecting portion 143. Block C includes an L-shaped pattern shown in FIG. 22B, and this pattern is detected by cross/L-shaped/T-shaped pattern detecting portion 143. Blocks B and D include T-shaped patterns shown in FIG. 22C, respectively, and these patterns are detected by cross/L-shaped/T-shaped pattern detecting portion 143.

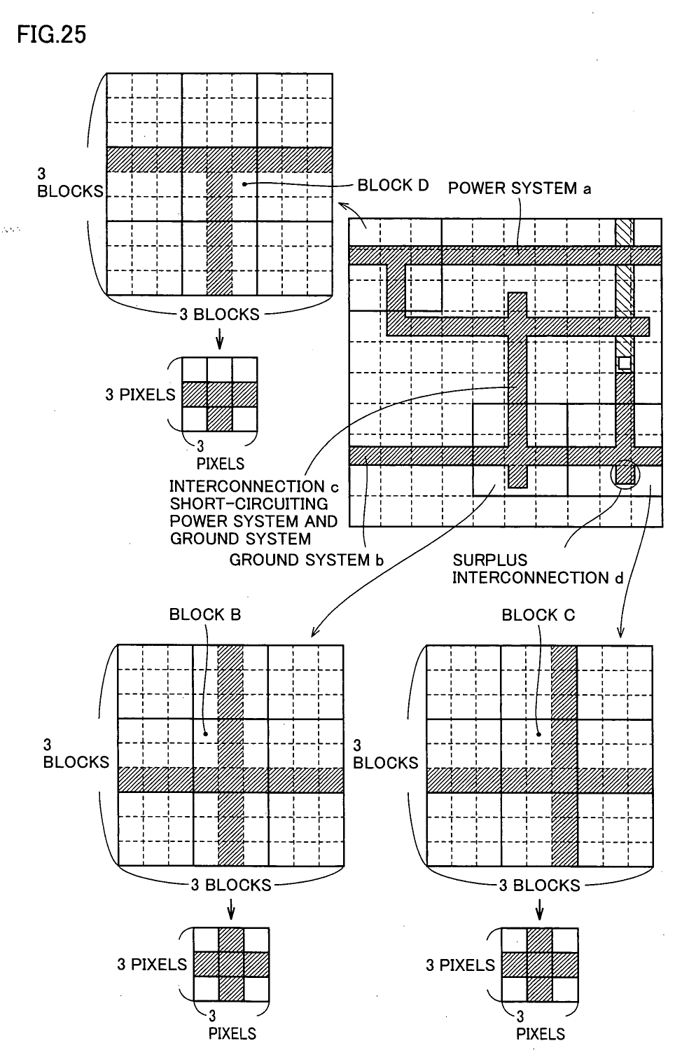

FIG. 25 shows a block group in the interconnection layout shown in FIG. 18B, and particularly shows the block group, in which the cross patterns are detected by the secondary detection processing of pattern recognizing device 140. Referring to FIG. 25, the cross pattern is detected by the secondary detection processing in the block group of 3-by-3 blocks formed of block B, in which a T-shaped pattern is detected by the primary detection processing, and eight blocks neighboring to block B. This is for the following reasons. Since all the pixels in each of the upper left, lower left, upper right and lower right blocks belonging to the above block group take the values of “0”, these blocks are reduced to the pixels of pixel values of “0”, respectively. Other blocks contain the pixels of pixel values of “1”, and therefore are reduced to the pixels of pixel values of “1”, respectively. The pixel group of 3-by-3 pixels thus produced contains the cross pattern. Therefore, the cross pattern is detected as described above.

Also, the cross pattern is detected by the secondary detection processing in the block group of 3-by-3 blocks formed of block C, in which an L-shaped pattern is detected by the primary detection processing, and eight blocks neighboring to block C. This is for the following reasons. Since all the pixels in each of the upper left, lower left, upper right and lower right blocks belonging to the above block group take the values of “0”, these blocks are reduced to the pixels of pixel values of “0”, respectively. Other blocks contain the pixels of pixel values of “1”, and therefore are reduced to the pixels of pixel values of “1”, respectively. The pixel group of 3-by-3 pixels thus produced contains the cross pattern. Therefore, the cross pattern is detected as described above.

Further, the cross pattern is not detected by the secondary detection processing in the block group of 3-by-3 blocks formed of block D, in which a T-shaped pattern is detected by the primary detection processing, and eight blocks neighboring to block D. This is for the following reasons. Since all the pixels in the upper left, lower left, upper right and lower right blocks belonging to the above block group as well as the upper middle block take the values of “0”, these blocks are reduced to the pixels of pixel values of “0”, respectively. Other blocks contain the pixels of pixel values of “1”, and therefore are reduced to the pixels of pixel values of “1”, respectively. The pixel group of 3-by-3 pixels thus produced does not contain the cross pattern. Therefore, the cross pattern is not detected, as described above.

As described above, layout verifying device 400 of the embodiment can easily detect the short-circuited and/or surplus portion with high reliability, similarly to the third embodiment. Further, the layout image is divided into blocks. Only when each of the blocks defined by dividing the layout image contains the T- or L-shaped pattern, it is determined whether the cross pattern is contained in the 3-by-3 blocks, which are formed of the above block containing the T- or L-shaped pattern as well as the eight blocks neighboring to this block, or not. Therefore, the presence of the short-circuited or surplus portion can be detected within a shorter time than the third embodiment.

The invention is not restricted to the foregoing embodiments, and may be modified as follows.

(1) Imaging Device

According to the third and fourth embodiments of the invention, imaging device 160 produces the layout image in such resolutions that the interconnection has the width of one pixel, and therefore pattern recognizing devices 130 and 140 handle blocks each formed of 3-by-3 pixels, and detect the cross, L-shaped and/or T-shaped pattern in each block. However, the invention is not restricted to such structures and manners.

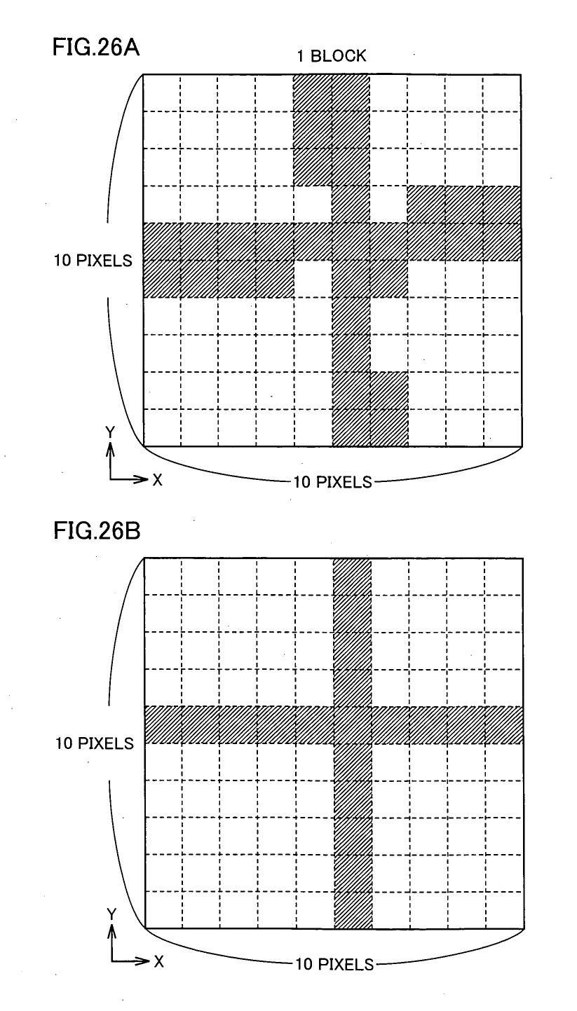

As shown in FIG. 26A, if imaging device 160 does not produce the layout image in such resolutions that the interconnection has the width of one pixel, the cross pattern cannot be detected from the one block formed of 3-by-3 pixels. Therefore, one block may be formed of 10-by-10 pixels, and it may be determined whether straight lines crossing each other are present in the one block or not. The crossing straight lines can be easily detected by a known image processing technology.

Alternatively, the layout image shown in FIG. 26A may be processed by line narrowing processing so that the interconnection may have a width of one pixel. FIG. 26B shows a layout image after the image of the interconnection is narrowed to have a width of one pixel. If the line narrowing processing is performed, it is determined whether the cross pattern in FIG. 16 (or FIG. 22A) is present in the block of 3-by-3 pixels or not, as is done in the third and fourth embodiments.

(2) Detection of the Cross Pattern by the Secondary Detection Processing

According to the secondary detection processing of the third and fourth embodiments of the invention, 3-by-3 blocks are reduced to one block, and it is determined whether the reduced block contains the cross pattern or not. However, another manner may be employed. It may be determined whether straight lines crossing each other are present in the 3-by-3, i.e., nine blocks or not.

(3) Target Block in the Secondary Detection Processing

In the fourth embodiment of the invention, the secondary detection processing for the block, which contains the T- or L-shaped pattern according to the result of the primary detection processing, is effected on the 3-by-3 blocks including this block and the eight blocks neighboring to it. However, another manner may be employed. For example, the secondary detection processing for the leftmost block in FIG. 22B containing the L-shaped pattern may be effected on 2-by-2 blocks including this leftmost block as well as the blocks located on the upper side, left side and the upper left side of the above leftmost block. For the rightmost block in FIG. 22B containing the L-shaped pattern, the secondary detection processing may be effected on 2-by-2 blocks including this rightmost block as well as the blocks located on the lower side, left side and the lower left side of the above rightmost block. For the leftmost block in FIG. 22C containing the T-shaped pattern, the secondary detection processing may be effected on 2 blocks including this leftmost block and the block on the lower side thereof For the rightmost block in FIG. 22C containing the T-shaped pattern, the secondary detection processing may be effected on 2 blocks including this rightmost block and the block on the upper side thereof.

(4) Cross, T- and L-shaped Patterns

According to the third and fourth embodiments of the invention, the short-circuited portion and/or the surplus portion are detected by utilizing the cross, L-shaped or T-shaped patterns. However, the pattern is not restricted to them. It is possible to use pixel patterns other than the above provided that the short-circuited portion and surplus portion can be detected.

(5) Production of the Layout Image

According to the second, third and fourth embodiments of the invention, imaging devices 160 and 165 produce the layout images by taking -pictures of the screen image of the display devices. However, another manner may be employed. For example, layout verifying devices 100, 200, 300 and/or 400 may be configured to write data in frame memories so that display device 150 can display the interconnections. In this case, the data in the frame memory may be obtained and used to produce the layout image.

(6) Program

Layout verifying devices 100, 200, 300 and/or 400 according to the embodiments of the invention are not restricted to devices formed of dedicated hardware. Functions of the respective components of layout verifying devices 100, 200, 300 and/or 400 may be achieved by programs executed-by a computer. Likewise, pattern recognizing devices 130 and 140 are not restricted to devices formed of dedicated hardware. Functions of the respective components of pattern recognizing devices 130 and/or 140 may be achieved by programs executed by a computer.

(7) Layout Verifying System

In the embodiments of the invention already described, layout verifying devices 100, 200, 300 and 400 are independent of pattern recognizing devices 130 and 140. However, another structure may be employed, and each of layout verifying devices 100, 200, 300 and 400 may include a pattern recognizing portion executing the function of pattern recognizing devices 130 or 140.

The layout verifying device may be configured to contain imaging device 160 (or 165) and/or display device 150 as components thereof.

(8) Display of Detour, Short-Circuited and Surplus Portions

According to the embodiments of the invention already described, the detour portion, short-circuited portion and surplus portion are highlighted for clear identification. However, this is not restrictive.

For example, instead of highlighting the pixels forming the cross pattern for distinguishing them from other pixels, a specific mark or a specific character may be displayed near the cross pattern. Thus, it is merely required to control of the display of the layout in a certain manner so that the position of the cross pattern can be identified.

(9) Detour Detection of Second Embodiment

According to the second embodiment of the invention, the detouring is detected by determining whether pixels continuously appear in the interconnection-allowed region. However, another manner may be employed. For example, the detouring may be detected by determining whether the pixel at the boundary of the interconnection-allowed region (i.e., pixels of the maximum and minimum values of X, and pixels of the maximum and minimum values of Y) are end points (other than the original end points connected to the terminals) or not.

Although the present invention has been described and illustrated in detail, it is clearly understood that the same is by way of illustration and example only and is not to be taken by way of limitation, the spirit and scope of the present invention being limited only by the terms of the appended claims.

1. A layout verifying device for verifying a layout of an interconnection comprising:
a unit determining an allowed region of arrangement of said interconnection based on a position of an element having a terminal connected to said interconnection; and
determining unit determining that said interconnection has a detouring form, when said interconnection does not stay within said allowed region.

2. The layout verifying device according to claim 1, wherein
said determining unit determines, based on coordinates of opposite ends of each of segments forming said interconnection and coordinates of a boundary of said allowed region, whether said segment stays within the interconnection allowed region or not, and determines according to results of the determination whether said interconnection stays within said allowed region or not.

3. The layout verifying device according to claim 1, wherein
said determining unit produces or obtains layout image data of the interconnection in said allowed region, and said determining unit determines based on said layout image data whether pixels representing the interconnection continuously appear or not, and determines according to results of the determination whether said interconnection stays within said allowed region or not.

4. A layout verifying device for verifying a layout of an interconnection comprising:
a unit producing or obtaining data of a layout image of the interconnection; and
determining unit determining that the interconnection in said layout image is short-circuited or has a surplus portion, when a predetermined pattern is present in a block defined by dividing said data of the layout image of the interconnection into the blocks.

5. The layout verifying device according to claim 4, wherein
said determining unit determines that said interconnection in the layout image is short-circuited or has the surplus portion, when a cross pattern is present in said block.

6. The layout verifying device according to claim 5, wherein
said determining unit determines that said interconnection in the layout image is short-circuited or has the surplus portion, when a cross pattern is present in a plurality of blocks including a block not containing said cross pattern and a plurality of blocks neighboring to said block not containing said cross pattern.

7. The layout verifying device according to claim 6, wherein
said determining unit controls display on a screen of said layout of the interconnection to allow identification of the positions of the cross pattern in said block and the cross pattern in said plurality of blocks.

8. The layout verifying device according to claim 5, wherein
said determining unit determines that said interconnection in the layout image is short-circuited or has the surplus portion, when a block containing an L- or T-shaped pattern is present, and a cross pattern is present in a plurality of blocks including said block and a plurality of blocks neighboring to said block
